(19) United States
(12) Patent Application Publication
(10) Pub. No.: US 2013/0025444 A1
(43) Pub. Date: Jan. 31, 2013

(54) POLYOLEFIN COMPOSITION AND METHOD FOR MANUFACTURING THEREOF

(71) Applicant: Johannes Bos, Apeldoorn (NL)

(72) Inventor: Johannes Bos, Apeldoorn (NL)

(73) Assignee: TEIJIN ARAMID B.V., Arnhem (NL)

(21) Appl. No.: 13/640,169

(22) PCT Filed: Apr. 7, 2011
(86) PCT No.: PCT/EP2011/055442

§ 371 Date: Oct. 9, 2012

(30) Foreign Application Priority Data
Apr. 8, 2010 (EP) 10159340.8

(51) Int. Cl. B32B 5/16; F41H 5/04; D02G 3/04; C08L 53/00; B27N 3/02; D02G 3/22

(52) U.S. Cl. 89/36.02; 264/115; 428/402; 428/338; 428/372; 525/98; 89/915

(57) ABSTRACT

A process for manufacturing a polyolefin powder having a thermoplastic elastomer includes the steps of
combining a polyolefin powder or a monomeric source therefor with a thermoplastic elastomer, the thermoplastic elastomer being in the form of a solution or dispersion in a solvent,
wherein where a monomeric source of a polyolefin is used, contacting the source of a polyolefin with a polymerization catalyst under polymerization conditions to form a polyolefin, and
removing the solvent to form a powder
   and wherein the polyolefin and the thermoplastic elastomer are not the same polymer. A particulate polyolefin composition which has a particle size distribution such that at least 80 vol. % of the particles has a diameter in the range of 1-3000 microns, and which includes a nascent polyolefin and 0.1-30 wt. % of a thermoplastic elastomer, calculated on the total of polyolefin and thermoplastic elastomer, is also described.

The present application is a U.S. national stage application of International Application No. PCT/EP2011/055442, filed Apr. 7, 2011, which claims priority to European Application No. 10159340.8, filed Apr. 8, 2010.

### BACKGROUND

The present invention pertains to a polyolefin composition. The present invention also pertains to a process for manufacturing such composition, to its use in the manufacture of polyolefin films and fibers, and to use of these materials in ballistic applications.

High-strength tapes and fibers of polyolefin, e.g., polyethylene are well known in the art. These materials are used, for example, in the manufacture of ballistic materials. Sometimes, polyolefins are combined with other materials, e.g., matrix materials, used to adhere the high-strength tapes and fibers together.

For example, EP833742 describes a ballistic resistant molded article containing a compressed stack of monolayers, with each monolayer containing unidirectionally oriented polyolefin fibers and at most 30 wt. % of an organic matrix material which may be a thermoplastic elastomer. The fibers may be polyethylene fibers.

WO 2010/007062 describes a ballistic-resistant molded article comprising a compressed stack of sheets comprising reinforcing elongate bodies, wherein at least some of the elongate bodies are polyethylene elongate bodies. This document mentions that the compressed stack may comprise a matrix material, which binds the elongate bodies and/or sheets together. The matrix material may be applied onto the surface of the sheet or may be applied by impregnating the elongate bodies in the manufacture of the sheet.

EP 2113376 describes a ballistic-resistant molded article comprising a compressed stack of sheets comprising tapes of a reinforcing material, characterised in that at least one sheet comprises woven tapes as weft and as warp. The tapes preferably are of polyethylene. This document also mentions that the ballistic-resistant molded article may comprise a matrix material, which may be an organic matrix material and preferably is an elastomer. The matrix material may be applied over the surface of the sheet.

### SUMMARY

While these materials show adequate properties, there is still need for improvement. The present invention provides polyolefin shaped objects, e.g., tapes, which show increased adherence to each other, while still showing adequate strength. The present invention also provides a starting material for manufacturing shaped objects, and processes for manufacturing the starting material and the shaped objects.

### DETAILED DESCRIPTION

In particular, the instant invention relates to a process for manufacturing a polyolefin powder comprising a thermoplastic elastomer, to a particulate polyolefin composition comprising a thermoplastic elastomer, and to shaped objects obtained from said particulate polyolefin composition.

The particulate polyolefin composition generally comprises 0.1-30 wt. % of the thermoplastic elastomer, calculated on the total of polyolefin and thermoplastic elastomer. The particulate polyolefin composition may also generally have a particle size distribution such that at least 80 vol. % of the particles has a diameter in the range of 1-3000 microns. The particulate polyolefin composition preferably comprises a nascent polyolefin.

In one embodiment, the present invention is directed to a particulate polyolefin composition which has a particle size distribution such that at least 80 vol. % of the particles has a diameter in the range of 1-3000 microns, and which comprises a nascent polyolefin and 0.1-30 wt. % of a thermoplastic elastomer, calculated on the total of polyolefin and thermoplastic elastomer. The composition according to this embodiment comprises a nascent polyolefin. In the art of polymer chemistry, nascent polyolefin is polyolefin which after it has been synthesized has not been subjected to any melting step or to any orientation step. It is also indicated as reactor powder, or as as-synthesized polymer. Whether or not a polyolefin is nascent can, e.g., be determined from the melting point of the polyolefin, because nascent polyolefin has a higher melting point than non-nascent polyolefin. For example, nascent polyethylene has a melting point of above 138° C., or even above 140° C., while polyethylene that has been subjected to a melting or orientation step has a melting temperature of the order of 135° C.

Generally, at least 80 vol. % of the particles of the polyolefin composition has a diameter in the range of 1-3000 microns, more in particular in the range of 1-2000 microns, still more in particular in the range of 10-300 microns. Preferably, at least 90 vol. %, more preferably at least 95 vol. %, still more preferably at least 98 vol. % of the particles has a diameter in the stipulated ranges. Suitable methods for determining the particle size distribution are known in the art.

The composition according to the invention generally comprises 0.1-30 wt. % of a thermoplastic elastomer, calculated on the total of polyolefin and thermoplastic elastomer. If the amount is too low, the advantageous effects of the present invention will not be obtained. If the amount of thermoplastic elastomer is too high, the amount of polyolefin will be correspondingly low, and this may affect the properties of the final material. In one embodiment, the amount of the thermoplastic elastomer in the final composition is between 0.1 and 20 wt. %, in particular between 0.5 and 15 wt. %, more in particular, between 1 and 10 wt. %.

2 0 The composition according to the invention comprises a thermoplastic elastomer. Thermoplastic elastomers (TPE), sometimes referred to as thermoplastic rubbers, are a class of copolymers or a physical mix of polymers (usually a plastic and a rubber) which consist of materials with both thermoplastic and elastomeric properties, i.e., it shows plastic flow above its Tg (glass transition temperature), Tm (melting point), or Ts (softening point) (thermoplastic behavior) and shows resilient properties below the softening point. In one embodiment, the material has an elongation at break of at least 100%, in particular at least 200%. The upper limit is not critical to the present invention. A value of 600% may be mentioned in general. Preferably the elongation at break of the elastomer is higher than the elongation at break of the fiber or tape that may be manufactured from the composition of the present invention, as will be discussed in more detail below. In one embodiment, the thermoplastic elastomer has a tensile modulus (at 25° C.) of at most 40 MPa.

Suitable thermoplastic elastomers include polyurethanes, polyvinyls, polyacrylates, block copolymers (such as polyisoprene-polyethylenebutylene-polystyrene and polystyrene-polyisoprene-polystyrene block copolymers) or mixtures thereof.

In one embodiment, the thermoplastic elastomer is a block copolymer of styrene and an alpha-olefin comonomer. Suitable eomonomers include C4-C12 alpha-olefins such as ethylene, propylene, and butadiene. The use of polystyrene-polybutadiene-polystyrene polymer or polystyrene—isoprene—polystyrene is considered preferred at this point in time. These kinds of polymers are commercially available with the trade name Kraton or Styroflex.

Suitable polyolefins for use in the composition according to the invention include polyolefins derived from C2-C12 olefin monomers such as ethylene, propylene, and 1-butene. In the present invention the use of homopolymers and copolymers of polyethylene and polypropylene is preferred. These polyolefins may contain small amounts of other monomers or polymers, in particular other alkene-1-polymers and monomers.

It is understood that the polyolefin as described herein and the thermoplastic elastomer are not the same polymer. In particular, the polyolefin does not have the characteristic properties of the thermoplastic elastomer, and the other way around. This is the case, for instance, of polyolefins derived from C2-C12 olefin monomers, such as ethylene, propylene and 1-butene, which do not generally behave as thermoplastic elastomers, even when they contain small amounts of other monomers or polymers.

As described above, the particulate polyolefin composition as described herein, allows for obtaining polyolefin shaped objects, e.g., tapes, which show increased adherence to each other while still showing adequate strength. The polyolefin as described herein being responsible for the strength of the shaped object and the thermoplastic polymer being responsible for the increased adherence of the shaped object.

The thermoplastic elastomer generally has a tensile modulus (at 25° C.) of at most 500 MPa, preferably of at most 100 MPa, more preferably of at most 40 MPa.

The polyolefin of the composition as described herein generally has a tensile modulus of at least 40 GPa, in particular at least 50 GPa. More in particular, the tensile modulus is at least 80 GPa, more in particular at least 100 GPa, still more in particular at least 120 GPa, even more in particular at least 140 GPa, or at least 150 GPa.

The tensile modulus is a measure of the stiffness of a material and may be determined in accordance with ASTM D882-00 (or its latest version ASTM D882-10) by making a film of the material to be measured, i.e., a film of the thermoplastic elastomer or the polyolefin, as the case may be.

In one embodiment of the present invention the polyolefin has a molecular weight of at least 100 000 gram/mole, in particular at least 500 000 gram/mole, more in particular at least 1 000 000 gram/mole. The molecular weight of the polyolefin generally is of at most 1.10⁸ gram/mole.

In another embodiment the polyolefin has a Mw (weight average molecular weight) over Mn (number average molecular weight) ratio of at most 6. More in particular the Mw/Mn ratio is at most 4, still more in particular at most 3, even more in particular at most 2. The weight average molecular weight, the molecular weight distribution and molecular weigh averages (Mw, Mn, Mz) of the polyolefin may be determined as described in WO2009/007045, such as ASTM D 6474-99.

In one embodiment of the present invention the polyolefin is polyethylene with a molecular weight of at least 100,000 gram/mole, in particular at least 500,000 gram/mole, more in particular at least 1,000,000 gram/mole.

The polyethylene used in the process according to the invention can be a homopolymer of ethylene or a copolymer of ethylene with a co-monomer which is an alpha-olefin or a cyclic olefin both with generally between 3 and 20 carbon atoms. Examples include propene, 1-butene, 1-pentene, 1-hexene, 1-heptene, 1-octene, cyclohexene, etc. The use of dienes with up to 20 carbon atoms is also possible, e.g., butadiene or 1-4 hexadiene. The amount of (non-ethylene)alpha-olefin in the ethylene homopolymer or copolymer used in the process according to the invention preferably is at most 10 mole %, preferably at most 5 mole %, more preferably at most 1 mole %. If a (non-ethylene) alpha-olefin is used, it is generally present in an amount of at least 0.001 mol.%, in particular at least 0.01 mole %, still more in particular at least 0.1 mole %.

In a specific embodiment of the present invention, the polyolefin is ultra-high molecular weight polyethylene (UHMWPE), that is, a polyethylene with a weight average molecular weight (Mw) of at least 500 000 gram/mole in particular between 1.10⁶ gram/mole and 1.10⁸ gram/mole. The molecular weight distribution and molecular weigh averages (Mw, Mn, Mz) of the polymer may be determined as described in WO2009/007045, such as ASTM D 6474-99.

In one embodiment, a nascent polyethylene is used which has a narrow molecular weight distribution. This is expressed by the Mw (weight average molecular weight) over Mn (number average molecular weight) ratio of at most 6. More in particular the Mw/Mn ratio is at most 4, still more in particular at most 3, even more in particular at most 2.

In one embodiment, the nascent polyethylene has an elastic shear modulus G_{N}⁰ determined directly after melting at 160° C. of at most 1.4 MPa, more in particular at most 1.0 MPa, still more in particular at most 0.9 MPa, even more in particular at most 0.8 MPa, and even more in particular at most 0.7. The wording “directly after melting” means that the elastic shear modulus is determined as soon as the polymer has melted, in particular within 15 seconds after the polymer has melted. For this polymer melt G_{N}⁰ typically increases from 0.6 to 2.0 MPa in one, two, or more hours, depending on the molar mass.

G_{N}⁰ is the elastic shear modulus in the rubbery plateau region. It is related to the average molecular weight between entanglements Me, which in turn is inversely proportional to the entanglement density. In a thermodynamically stable melt having a homogeneous distribution of entanglements, Me can be calculated from G_{N}⁰ via the formula G_{N}⁰=g_{N}ρRT/Mₑ where g_{N} is a numerical factor set at 1, rho is the density in g/cm3, R is the gas constant and T is the absolute temperature in K.

A low elastic shear modulus thus stands for long stretches of polymer between entanglements, and thus for a low degree of entanglement. The adopted method for the investigation on changes in G_{N}⁰ with the entanglements formation is the same as described in publications (Rastogi, S., Lippits, D., Peters, G., Graf, R., Yefeng, Y. and Spiess, H., “Heterogeneity in Polymer Melts from Melting of Polymer Crystals”, Nature Materials, 4(8), 1st Aug. 2005, 635-641 and PhD thesis Lippits, D. R., “Controlling the melting kinetics of polymers; a route to a new melt state”, Eindhoven University of Technology, dated 6th Mar. 2007, ISBN 978-90-386-0895-2).

In one embodiment, a polymer is used which shows a strain hardening slope of below 0.10 N/mm at 135° C. and/or of below 0.12 N/mm at 125° C. The strain hardening slope is determined by subjecting compressed polymer to a drawing step under specific conditions. The test is carried out as follows: polymer powder is subjected to compaction at a pressure of 200 bar, at 130° C., for 30 minutes to form tensile bars with a thickness of 1 mm, a width of 5 mm and a length of 15 mm. The bars are subjected to drawing at a tensile speed of 100 mm/min at a temperature of 125° C. or 135° C. The drawing temperature is chosen such that no melting of the polymer occurs. The bar is drawn from 10 mm to 400 mm. For the tensile test a force cell of 100N is used. The force cell measures force required for the elongation of the sample at the fixed temperature. The force/elongation curve shows a first maximum, which is also known as the yield point. The strain hardening slope is defined as the steepest positive slope in the force/elongation curve after the yield point. In one embodiment of the present invention, the polymer has a strain hardening slope, determined at 135° C., of below 0.10 N/mm, in particular below 0.06 N/mm, more in particular below 0.03 N/mm. In another embodiment, the polymer has a strain hardening slope, determined at 125° C., of below 0.12 N/mm, in particular below 0.08 N/mm, more in particular below 0.03 N/mm. In a preferred embodiment, the polymer meets the stipulated requirements both at 125° C. and at 135° C. While not wishing to be bound by theory, a low strain hardening slope means that the material has high drawability at low stress. It is believed that this means in turn that the polymer chains contain few entanglements, and that this will enable the manufacture of tape with good properties in accordance with the present invention.

The UHMWPE that may be used in the present invention preferably has a DSC crystallinity of at least 60%, more in particular at least 67%. The crystallinity of the material may be 3 0 characterised using differential scanning calorimetry (DSC), for example on a TA-Instruments Q2000. A sample of known weight (0.2-0.3 mg) is heated from 30 to 180° C. at 10° C. per minute. The results of the DSC scan may be plotted as a graph of heat flow (mW or mJ/s; y-axis) against temperature (x-axis). The crystallinity is measured using the data from the heating portion of the scan. An enthalpy of fusion ΔH (in J/g) for the crystalline melt transition is calculated by determining the area under the graph from the temperature determined just below the start of the main melt transition (endotherm) to the temperature just above the point where fusion is observed to be completed. The calculated ΔH is then compared to the theoretical enthalpy of fusion (ΔH_{c} of 293 J/g) determined for 100% crystalline PE at a melt temperature of approximately 140° C. A DSC crystallinity index is expressed as the percentage 100(ΔH/ΔH_{c}).

In one embodiment, an UHMWPE is used in the present invention which has a bulk density which is significantly lower than the bulk density of conventional UWMWPEs, e.g., below 0.25 g/cm³, in particular below 0.18 g/cm³, still more in particular below 0.13 g/cm³. The bulk density may be determined in accordance with ASTM-D1895. A fair approximation of this value can be obtained as follows. A sample of UHMWPE powder is poured into a measuring cylinder of exact 100 ml. After scraping away the surplus of material, the weight of the content of the beaker is determined and the bulk density is calculated.

The particulate polyolefin composition according to the invention may be manufactured by a process which comprises the following steps:
a) combining a polyolefin powder or a monomeric source therefor with a thermoplastic elastomer, the thermoplastic elastomer being in the form of a solution or dispersion in a solvent
b) where a monomeric source of a polyolefin is used, contacting the source of a polyolefin with a polymerization catalyst under polymerization conditions to form a polyolefin
c) removing the solvent to form a powder.

In essence, the above process consists of two embodiments. In the first embodiment the thermoplastic elastomer is combined with the polyolefin powder, which preferably is in its nascent state (i.e. nascent polyolefin powder). In the second embodiment, the thermoplastic elastomer is combined with a monomeric source for the polymer, and the polyolefin is polymerized in the presence of the monomer.

In the present specification the word catalyst encompasses both single-component catalysts and catalyst systems which comprise the combination of a catalytically active component and a co-catalyst. Both types of catalysts are known in the art,

The thermoplastic elastomer is applied in the form of a solution or dispersion in a solvent. The solvent is a material which is suitable as solvent or dispersant for the thermoplastic elastomer. The polyolefin should be substantially insoluble in the solvent. More in particular, the solubility of the polyolefin in the solvent should be less than 0.1 wt. % mole/gram at room temperature.

The solvent should be such that the thermoplastic elastomer can be dissolved or dispersed therein. The aim is to ensure an intimate mixture between the polyolefin and the thermoplastic elastomer. Therefore, the solvent and the thermoplastic elastomer should be matched to each other so that the thermoplastic elastomer dissolves in the solvent, or at least disperses in it in the form of swollen particles.

Examples of suitable solvents include aromatic solvents like toluene, benzene, ethylbenzene, dimethylbenzene (and its isomers). Within this group toluene is preferred. Examples of suitable solvents include aliphatic solvents like cyclohexane, hexane, octane, paraffine. Within this group cyclohexane is preferred. Acetates may also be used. Examples include ethylacetate, propylacetate, butylacetate, and amylacetate. Within this group butylactetate is preferred. Ethers may also be used. Within this group, diethyl ether is preferred.

The concentration of the thermoplastic elastomer in the solvent is not critical to the present invention. The lower the concentration, the more solvent will be required to bring the desired amount of thermoplastic elastomer into the polymer compostion. Accordingly, for practical purposes there may be a minimum concentration, of say, 1 wt. %. The upper limit of the concentration is determined by the solubility of the thermoplastic elastomer in the solvent. Where the concentration is very high, the mixture may become viscous, or it may become difficult to homogeneously combine the poylolefin with the solution or dispersion. Accordingly, for practical purposes, an upper limit for the concentration of 40 wt. % may be mentioned. In one embodiment of the present invention, the concentration of the polyolefin in the solvent may be between 2 and 25 wt. %, more specifically between 5 and 20 wt. %. Determination of the appropriate amount is well within the scope of the skilled person.

As will be discussed in more detail below, the dispersion or solution of the thermoplastic elastomer in a solvent is combined with a polyolefin powder or a monomeric source therefor. The manner in which this combination is carried out is not critical to the present invention, as long as the solvent is intimately mixed with the polymer powder or polymer source. It is within the scope of the skilled person to determine an appropriate manner of mixing.

Subsequently, the solvent is removed from the composition. This can be done in a conventional manner, e.g., by one or more of filtration, decantation, and evaporation, at atmospheric or reduced pressure. During solvent removal care should be taken not to remove the thermoplastic elastomer when it is dissolved in the solvent. Therefore, filtration and decantation may sometimes be less suitable.

The solvent content of the final product is generally below 1 wt. %, preferably below 0.5 wt. %, more in particular below 0.1 wt. %.

In one embodiment of the process according to the invention, a polyolefin powder is combined with a solution or dispersion of a thermoplastic elastomer, after which the solvent is removed. In this embodiment, the thermoplastic elastomer is preferably combined with polyolefin powder in its nascent form. Optionally, the polyolefin powder has been subjected to conventional pre-treatment steps such as washing and drying, as long as the nascent character of the material is not affected. It will be evident to the skilled person which type of pre-treatment steps may suitably be applied. The nascent polyolefin will have a particle size distribution which meets the requirements discussed above for the particulate polyolefin composition according to the invention.

In another embodiment of the present invention, the thermoplastic elastomer is combined with a monomer source for a polyolefin in the presence of a solvent, followed by contacting the source of a polyolefin with a polymerization catalyst under polymerization conditions to form a polyolefin.

The polymerization process may be carried out by processes known in the art. In one embodiment, the catalyst is a single-site catalyst. In one embodiment, the polymerization process is carried out at a temperature below the crystallisation temperature of the polymer, so that the polymer crystallises immediately upon formation. In this embodiment, reaction conditions may be selected such that the polymerization speed is lower than the crystallisation speed. These synthesis conditions force the molecular chains to crystallize immediately upon their formation, leading to morphology which differs substantially from the one obtained from the solution or the melt. The crystalline morphology created at the surface of a catalyst will highly depend on the ratio between the crystallization rate and the growth rate of the polymer. Moreover, the temperature of the synthesis, which is in this particular case also crystallization temperature, will strongly influence the morphology of the obtained powder. In one embodiment the reaction temperature is between −50 and +50° C., more in particular between −15 and +30° C. It is well within the scope of the skilled person to determine via routine trial and error which reaction temperature is appropriate in combination with which type of catalyst, polymer concentrations and other parameters influencing the reaction. When it is desired to obtain a highly disentangled UHMWPE it is important that the polymerization sites are sufficiently far removed from each other to prevent entangling of the polymer chains during synthesis. This can be done using a single-site catalyst which is dispersed homogenously through the crystallisation medium in low concentrations. More in particular, concentrations less than 1.10-4 mol catalyst per liter, in particular less than 1.10-5 mol catalyst per liter reaction medium may be appropriate. Supported single site catalyst may also be used, as long as care is taken that the active sites are sufficiently far removed from each other to prevent substantial entanglement of the polymers during formation. Suitable methods for manufacturing starting UHMWPE used in the present invention are known in the art. Reference is made, for example to WO01121668 and US20060142521.

When the polymerization reaction is completed, the solvent is removed as was described above. The product has a final solvent content as also described above.

The particulate product according to the invention can be processed further in a number of ways. In general, the particulate product can be converted to a shaped object by a shaping step. Suitable shaping steps are known in the art and encompass sintering or compression molding.

In one embodiment, the polyolefin containing the thermoplastic elastomer, in particular the ultra-high molecular weight polyethylene, still more in particular the disentangled UHMWPE is converted to films using a solid state film manufacturing process comprising the steps of subjecting the starting polyolefin, in particular the ultra-high molecular weight polyethylene, still more in particular the disentangled UHMWPE, to a compacting step and a stretching step under such conditions that at no point during the processing of the polymer its temperature is raised to a value above its melting point. The compacting step is carried out to integrate the polymer particles into a single object, e.g., in the form of a mother sheet. The stretching step is carried out to provide orientation to the polymer and manufacture the final product. The two steps may for example be carried out at a direction perpendicular to each other. It is noted that it is within the scope of the present invention to combine these elements in a single step, or to carry out the process in different steps, each step performing one or more of the compacting and stretching elements. For example, in one embodiment of the process according to the invention, the process comprises the steps of compacting the polymer powder to form a mothersheet, rolling the plate to form rolled mothersheet and subjecting the rolled mothersheet to a stretching step to form a polymer film.

The compacting force applied in the process according to the invention generally is 10-10000 N/cm², in particular 50-5000 N/cm2, more in particular 100-2000 N/cm². The density of the material after compacting is generally between 0.8 and 1 kg/dm³, in particular between 0.9 and 1 kg/dm³.

Where disentangled UHMWPE is used in the invention the compacting and rolling step is generally carried out at a temperature of at least 1° C. below the unconstrained melting point of the polymer, in particular at least 3° C. below the unconstrained melting point of the polymer, still more in particular at least 5° C. below the unconstrained melting point of the polymer. Generally, the compacting step is carried out at a temperature of at most 40° C. below the unconstrained melting point of the polymer, in particular at most 30° C. below the unconstrained melting point of the polymer, more in particular at most 10° C. In the process of this embodiment the stretching step is generally carried out at a temperature of at least 1° C. below the melting point of the polymer under process conditions, in particular at least 3° C. below the melting point of the polymer under process conditions, still more in particular at least 5° C. below the melting point of the polymer under process conditions. As the skilled person is aware, the melting point of polymers may depend upon the constraint under which they are put. This means that the melting temperature under process conditions may vary from case to case. It can easily be determined as the temperature at which the stress tension in the process drops sharply. Generally, the stretching step is carried out at a temperature of at most 30° C. below the melting point of the polymer under process conditions, in particular at most 20° C. below the melting point of the polymer under process conditions, more in particular at most 15° C.

The unconstrained melting temperature of the starting polymer is between 138 and 142° C. and can easily be determined by the person skilled in the art. With the values indicated above this allows calculation of the appropriate operating temperature. The unconstrained melting point may be determined via DSC (differential scanning calorimetry) in nitrogen, over a temperature range of +30 to +180° C. and with an increasing temperature rate of 10° C./minute. The maximum of the largest endothermic peak at from 80 to 170° C. is evaluated here as the melting point.

The stretching step in the process according to the invention is carried out to manufacture the polymer film. The stretching step may be carried out in one or more steps in a manner conventional in the art. A suitable manner includes leading the film in one or more steps over a set of rolls both rolling in process direction wherein the second roll rolls faster that the first roll. Stretching can take place, e.g., over a hot plate or in an air circulation oven.

In one embodiment of the present invention, in particular for disentangled polyethylene, the stretching step encompasses at least two individual stretching steps, wherein the first stretching step is carried out at a lower temperature than the second, and optionally further, stretching steps. In one embodiment, the stretching step encompasses at least two individual stretching steps wherein each further stretching step is carried out at a temperature which is higher than the temperature of the preceding stretching step. As will be evident to the skilled person, this method can be carried out in such a manner that individual steps may be identified, e.g., in the form of the films being fed over individual hot plates of a specified temperature. The method can also be carried out in a continuous manner, wherein the film is subjected to a lower temperature in the beginning of the stretching process and to a higher temperature at the end of the stretching process, with a temperature gradient being applied in between. This embodiment can for example be carried out by leading the film over a hot plate which is equipped with temperature zones, wherein the zone at the end of the hot plate nearest to the compaction apparatus has a lower temperature than the zone at the end of the hot plate furthest from the compaction apparatus. In one embodiment, the difference between the lowest temperature applied during the stretching step and the highest temperature applied during the stretching step is at least 3° C., in particular at least 7° C., more in particular at least 10° C. In general, the difference between the lowest temperature applied during the stretching step and the highest temperature applied during the stretching step is at most 30° C., in particular at most 25° C.

Depending on the properties of the polymer, the total stretching ratio of the film can be relatively high. For example, the total stretching ratio may be at least 80, in particular at least 100, more in particular at least 120. For disentangled polyethylene higher values, e.g. at least 140, more in particular at least 160 may be mentioned. The total stretching ratio is defined as the area of the cross-section of the compacted mothersheet divided by the cross-section of the drawn film produced from this mothersheet.

In one embodiment, the stretching step of the process according to the invention can be carried out in such a manner that the stretching step from a material with a modulus of 60 GPa to a material with a modulus of at least at least 80 GPa, in particular at least 100 GPa, more in particular at least 120 GPa, at least 140 GPa, or at least 150 GPa is carried out at the rate indicated above.

In will be evident to the skilled person that the intermediate products with a strength of 1.5 GPa, a stretching ratio of 80, and/or a modulus of 60 GPa are used, respectively, as starting point for the calculation of when the high-rate stretching step starts. This does not mean that a separately identifiable stretching step is carried out where the starting material has the specified value for strength, stretching ratio, or modulus. A product with these properties may be formed as intermediate product during a stretching step. The stretching ratio will then be calculated back to a product with the specified starting properties. It is noted that the high stretching rate described above is dependent upon the requirement that all stretching steps, including the high-rate stretching step or steps are carried out at a temperature below the melting point of the polymer under process conditions.

The present invention also pertains to shaped objects comprising the polyolefin comprising a thermoplastic elastomer. Shaped objects are, for example, films, tapes, fibers, filaments, and products which contain these materials, such as ropes, cables, nets, fabrics, and protective appliances such as ballistic resistant molded articles.

Incidentally, it is known in the art to provide polyolefin shaped objects films with a coating of a thermoplastic elastomer. This is, for example, described in EP833742, which describes a ballistic resistant molded article containing a compressed stack of monolayers, with each monolayer containing unidirectionally oriented polyolefin fibers and at most 30 wt. % of an organic matrix material which may be a thermoplastic elastomer. The fibers may be polyethylene fibers. In contrast, the shaped objects of the present invention comprise a thermoplastic elastomer distributed throughout the shaped object. Within the context of the present application a distribution throughout the shaped object means that thermoplastic elastomer may be found at all locations within the object. The difference between a polyolefin object coated with a matrix and an object according to the invention can be assessed using scanning electromicroscopy.

In one embodiment, the present invention pertains to polyolefin films comprising a thermoplastic elastomer distributed throughout the film, in particular an UHMWPE film, wherein the film has one or more of a high tensile strength, a high tensile modulus, and a high tensile energy-to-break.

In one embodiment, the tensile strength is at least 1.0 GPa, in particular at least 1.2 GPa, more in particular at least 1.5 GPa, still more in particular at least 1.8 GPa, even more in particular at least 2.0 GPa, still more in particular at least 2.5 GPa, more in particular at least 3.0 GPa, still more in particular at least 4 GPa. Tensile strength is determined in accordance with ASTM D882-00 or ASTM D882-10.

In one embodiment, the tensile modulus is at least 40 GPa, in particular at least 50 GPa. The modulus is determined in accordance with ASTM D882-00 or ASTM D882-10. More in particular, the tensile modulus is at least 80 GPa, more in particular at least 100 GPa, still more in particular at least 120 GPa, even more in particular at least 140 GPa, or at least 150 GPa.

In one embodiment, the tensile energy to break is at least 5 J/g, in particular at least 10 J/g, more in particular at least 15 J/g, even more in particular at least 20 J/g, still more in particular at least 30 J/g, or at least 40 J/g. The tensile energy to break is determined in accordance with ASTM D882-00 or ASTM D882-10 using a strain rate of 50%/min. It is calculated by integrating the energy per unit mass under the stress-strain curve.

In one embodiment of the present invention, the films have a 200/110 uniplanar orientation parameter Φ of at least 3. The 200/110 uniplanar orientation parameter Φ is defined as the ratio between the 200 and the 110 peak areas in the X-ray diffraction (XRD) pattern of the tape sample as determined in reflection geometry. For the meaning and determination method for this parameter reference is made to W02009/007045.

It may be preferred for this value to be at least 4, more in particular at least 5, or at least 7. Higher values, such as values of at least 10 or even at least 15 may be particularly preferred. The theoretical maximum value for this parameter is infinite if the peak area 110 equals zero. High values for the 200/110 uniplanar orientation parameter are often accompanied by high values for the strength and the energy to break.

The shaped object according to the invention may also be a fiber. For strength, modulus, and energy to break of the fibers, the same preferred ranges apply as have been specified above for the films.

Suitable fibers can be obtained from the films as described above including mechanical division processes, e.g., via slitting. The process as described above will yield tapes. They can be converted into fibers via methods known in the art including mechanical division processes, e.g., via slitting. They can also be obtained via a process comprising subjecting a polyethylene tape with a weight average molecular weight of at least 100,000 gram/mole, an Mw/Mn ratio of at most 6, and a 200/110 uniplanar orientation parameter of at least 3 to a force in the direction of the thickness of the tape over the whole width of the tape. Again, for further elucidation and preferred embodiments as regards the molecular weight and the Mw/Mn ratio of the starting tape, reference is made to what has been stated above. For a further description of this method reference is made to WO2010/003971.

In one embodiment of the present invention, the fibers have a 020 uniplanar orientation parameter of at most 55°. The 020 uniplanar orientation parameter gives information about the extent of orientation of the 020 crystal planes with respect to the fiber surface. For the value and determination method of this parameter reference is made to WO2010/003971. The 020 uniplanar orientation parameter preferably is at most 45°, more preferably at most 30°. In some embodiments the 020 uniplanar orientation value may be at most 25°. It has been found that fibers which have a 020 uniplanar orientation parameter within the stipulated range have a high strength and a high elongation at break. In the present specification, the 020 uniplanar orientation parameter will be used only for fibers with a width smaller than 0.5 mm.

In one embodiment, the width of the film is generally at least 5 mm, in particular at least 10 mm, more in particular at least 20 mm, still more in particular at least 40 mm. The width of the film is generally at most 200 mm. The thickness of the film is generally at least 8 microns, in particular at least 10 microns. The thickness of the film is generally at most 150 microns, more in particular at most 100 microns. In one embodiment, films are obtained with a high strength, as described above, in combination with a high linear density. In the present application the linear density is expressed in dtex. A tex is the weight in grams of 10,000 meters of film. In one embodiment, the film according to the invention has a linear density of at least 3000 dtex, in particular at least 5000 dtex, more in particular at least 10000 dtex, even more in particular at least 15000 dtex, or even at least 20000 dtex, in combination with strengths of, as specified above, at least 2.0 GPa, in particular at least 2.5 GPA, more in particular at least 3.0 GPa, still more in particular at least 3.5 GPa, and even more in particular at least 4.

It has been found that the shaped objects of the present invention are particularly suitable for use in ballistic material. The present invention also pertains to a ballistic-resistant molded article comprising a compressed stack of sheets comprising reinforcing elongate bodies, wherein at least some of the elongate bodies are polyolefin elongate bodies which have a thermoplastic elastomer distributed throughout the bodies. For preferred embodiments as regards the nature and amount of thermoplastic elastomer, the olefin, and the properties of the shaped bodies, reference is made to what has been stated above.

Within the context of the present specification the word elongate body means an object the largest dimension of which, the length, is larger than the second smallest dimension, the width, and the smallest dimension, the thickness. More in particular, the ratio between the length and the width generally is at least 10. The maximum ratio is not critical to the present invention and will depend on processing parameters. As a general value, a maximum length to width ratio of 1,000,000 may be mentioned. Accordingly, the elongate bodies used in the present invention encompass monofilaments, multifilament yarns, threads, tapes, strips, staple fiber yarns and other elongate objects having a regular or irregular cross-section. Within the present specification, the term sheet refers to an individual sheet comprising elongate bodies, which sheet can individually be combined with other, corresponding sheets. The sheet may or may not comprise a matrix material, as will be elucidated below.

As indicated above, at least some of the elongate bodies in the ballistic-resistant molded article are polyolefin elongated bodies meeting the stated requirements. To obtain the effect of the present invention, it is preferred for at least 20 wt. %, calculated on the total weight of the elongated bodies present in the ballistic resistant molded article, of the elongated bodies to be polyethylene elongate bodies meeting the requirements of the present invention, in particular at least 50 wt. %. More in particular, at least 75 wt. %, still more in particular at least 85 wt. %, or at least 95 wt. % of the elongated bodies present in the ballistic resistant molded article meets said requirements. In one embodiment, all of the elongated bodies present in the ballistic resistant molded article meet said requirements.

The sheets may encompass the reinforcing elongate bodies as parallel fibers or tapes. When tapes are used, they may be next to each other, but if so desired, they may partially or wholly overlap. The elongate bodies may be formed as a felt, knitted, or woven, or formed into a sheet by any other means.

The compressed stack of sheets may or may not comprise a matrix material. The term “matrix material” means a material which binds the elongate bodies and/or the sheets together. When matrix material is present in the sheet itself, it may wholly or partially encapsulates the elongate bodies in the sheet. When the matrix material is applied onto the surface of the sheet, it will act as a glue or binder to keep the sheets together. In the present specification the wording matrix material refers to the use of an additional material to the thermoplastic elastomer present in the sheets.

It is a feature of the present invention that because the shaped bodies contain a thermoplastic elastomer which is distributed homogeneously through the elongate bodies, it is not necessary to provide an additional matrix material. The thermoplastic elastomer present in the elongate bodies is generally sufficient to provide the required adhesion between the elongate bodies.

In one embodiment of the present invention, the sheet does not contain a matrix material. The sheet may be manufactured by the steps of providing a layer of elongate bodies and where necessary adhering the elongate bodies together by the application of heat and pressure. It is a feature of the present invention that the elongate bodies can in fact adhere to each other by the application of heat and pressure. In one embodiment of this embodiment, the elongate bodies overlap each other at least partially, and are then compressed to adhere to each other. This embodiment is particularly attractive when the elongate bodies are in the form of tapes.

If so desired, a matrix material may be applied onto the sheets to adhere the sheets to each other during the manufacture of the ballistic material. The matrix material can be applied in the form of a film or, preferably, in the form of a liquid material, both as described, e.g., in WO2009/109632. In the case that a matrix material is used in the compressed stack in accordance with the invention, the matrix material is present in the compressed stack in an amount of 0.2-40 wt. %, calculated on the total of elongate bodies and organic matrix material. The use of more than 40 wt. % of matrix material was found not to further increase the properties of the ballistic material, while only increasing the weight of the ballistic material. Where present, it may be preferred for the matrix material to be present in an amount of at least 1 wt. %, more in particular in an amount of at least 2 wt. %, in some instances at least 2.5 wt. %. Where present, it may be preferred for the matrix material to be present in a amount of at most 30 wt. %, sometimes at most 25 wt. %. In one embodiment of the present invention, a relatively low amount of matrix material is used, namely an amount in the range of 0.2-8 wt. %. In this embodiment it may be preferred for the matrix material to be present in an amount of at least 1 wt. %, more in particular in an amount of at least 2 wt. %, in some instances at least 2.5 wt. %. In this embodiment it may be preferred for the matrix material to be present in a amount of at most 7 wt. %, sometimes at most 6.5 wt. %.

The compressed sheet stack of the present invention should meet the requirements of class II of the NIJ Standard—0101.04 P-BFS performance test. In a preferred embodiment, the requirements of class IIIa of said Standard are met, in an even more preferred embodiment, the requirements of class III are met, or the requirements of other classes, such as class IV. This ballistic performance is preferably accompanied by a low areal weight, in particular an areal weight of at most 19 kg/m², more in particular at most 16 kg/m². In some embodiments, the areal weight of the stack may be as low as 15 kg/m². The minimum areal weight of the stack is given by the minimum ballistic resistance required.

The ballistic-resistant material according to the invention preferably has a peel strength of at least 5N, more in particular at least 5.5 N, determined in accordance with ASTM-D 1876-00, except that a head speed of 100 mm/minute is used.

Depending on the final use and on the thickness of the individual sheets, the number of sheets in the stack in the ballistic resistant article according to the invention is generally at least 2, in particular at least 4, more in particular at least 8. The number of sheets is generally at most 500, in particular at most 400.

In one embodiment of the present invention the direction of elongate bodies within the compressed stack is not unidirectionally. This means that in the stack as a whole, elongate bodies are oriented in different directions.

In one embodiment of the present invention the elongate bodies in a sheet are unidirectionally oriented, and the direction of the elongate bodies in a sheet is rotated with respect to the direction of the elongate bodies of other sheets in the stack, more in particular with respect to the direction of the elongate bodies in adjacent sheets. Good results are achieved when the total rotation within the stack amounts to at least 45 degrees. Preferably, the total rotation within the stack amounts to approximately 90 degrees. In one embodiment of the present invention, the stack comprises adjacent sheets wherein the direction of the elongated bodies in one sheet is perpendicular to the direction of elongated bodies in adjacent sheets. It is noted that the sheets in this embodiment may in themselves comprise overlapping parallel elongate bodies, e.g., in a bricklayered arrangement as discussed above.

the invention also pertains to a method for manufacturing a ballistic-resistant molded article comprising the steps of providing sheets comprising reinforcing elongate bodies at least some of which are polyolefin elongate bodies which comprise a thermoplastic elastomer distributed throughout the elongate bodies, stacking the sheets and compressing the stack under a pressure of at least 0.5 MPa.

In one embodiment of the present invention the sheets are stacked in such a manner that the direction of the elongated bodies in the stack is not unidirectional.

In one embodiment of this process, the sheets are provided by providing a layer of elongate bodies and causing the bodies to adhere, e.g., by compressing the bodies as such. In the latter embodiment it may be desired to apply matrix material onto the sheets before stacking. The pressure to be applied is intended to ensure the formation of a ballistic-resistant molded article with adequate properties. The pressure is at least 0.5 MPa. A maximum pressure of at most 80 MPA may be mentioned.

Where necessary, the temperature during compression is selected such that the matrix material is brought above its softening or melting point, if this is necessary to cause the matrix to help adhere the elongate bodies and/or sheets to each other. Compression at an elevated temperature is intended to mean that the molded article is subjected to the given pressure for a particular compression time at a compression temperature above the softening or melting point of the organic matrix material and below the softening or melting point of the elongate bodies. In one embodiment this step is carried out under such conditions that no relaxation occurs.

The required compression time and compression temperature depend on the kind of elongate body and matrix material and on the thickness of the molded article and can be readily determined by one skilled in the art.

Where the compression is carried out at elevated temperature, the cooling of the compressed material should also take place under pressure. Cooling under pressure is intended to mean that the given minimum pressure is maintained during cooling at least until so low a temperature is reached that the structure of the molded article can no longer relax under atmospheric pressure. It is within the scope of the skilled person to determine this temperature on a case by case basis. Where applicable it is preferred for cooling at the given minimum pressure to be down to a temperature at which the organic matrix material has largely or completely hardened or crystallized and below the relaxation temperature of the reinforcing elongate bodies. The pressure during the cooling does not need to be equal to the pressure at the high temperature. During cooling, the pressure should be monitored so that appropriate pressure values are maintained, to compensate for decrease in pressure caused by shrinking of the molded article and the press.

Depending on the nature of the matrix material, for the manufacture of a ballistic-resistant molded article in which the reinforcing elongate bodies in the sheet are high-drawn elongate bodies of high-molecular weight linear polyethylene, the compression temperature is preferably 115 to 135° C. and cooling to below 70° C. is effected at a constant pressure. Within the present specification the temperature of the material, e.g., compression temperature refers to the temperature at half the thickness of the molded article.

In the process of the invention the stack may be made starting from loose sheets. Loose sheets are difficult to handle, however, in that they easily tear in the direction of the elongate bodies. It may therefore be preferred to make the stack from consolidated sheet packages containing from 2 to 50 sheets. In one embodiment, stacks are made containing 2-8 sheets. In another embodiment, stacks are made of 10-30 sheets. For the orientation of the sheets within the sheet packages, reference is made to what has been stated above for the orientation of the sheets within the compressed stack.

Consolidated is intended to mean that the sheets are firmly attached to one another. Very good results are achieved if the sheet packages, too, are compressed.

The invention will be illustrated by the following examples, without being limited thereto or thereby.

### EXAMPLES

### Example 1

### Ultra-High Molecular Weight Polyethylene with a Styrene-Butadiene-Styrene Block Copolymer

Polymer blends were manufactured as follows:

Into a 1 l beakerglass containing 150 ml solvent, a styrene-butadiene-styrene block copolymer (SBS, Styroflex 2G66 (BASF)) was added while continuously stirring. After dissolution 90 g ultra-high molecular polyethylene (UHMWPE, Ticona GUR 168X) was added and the mixture was mixed thoroughly. The mixture was put into a vacuum oven at 40° C. for at least 12 h. The mixture was stirred 3-4 times. The resulting material was a free-flowing powder. Manufacturing and composition details are presented in the following table.

| | | | | wt % SBS |
|---|---|---|---|---|
| | | polyethylene | SBS | (on total of PE and |
| | Solvent | (gram) | (gram) | SBS) |
| Blend 1 | Toluene | 90 | 1.84 | 2.00 |
| Blend 2 | Toluene | 90 | 4.74 | 5.00 |
| Blend 3 | Butylacetate | 90 | 4.74 | 5.00 |

Tapes were manufactured from the blends as follows:

A mold with a cavity of 620*30 mm was filled with 25 g polymer powder and compressed at 137-138° C. at 140 bar for 7 min to form a sheet.

The sheet was preheated at 138° C. for 1 min, and rolled with a Collin Calander (diameter rolls: 250 mm, slit distance 0.1 mm, inlet speed 0.5 m/min). The tape was immediately stretched on a roll (speed 2.5 m/min).

The tape was stretched in two steps on a 50 cm long oil heated hotplate at 154° C. The tape made contact with the hotplate after 20 cm from the entrance of the hotplate.

The properties of the tapes, and those of a tape of the same polymer not containing the thermoplastic elastomer, are given in the following table.

| | | | Tensile | | Energy | Elongation |
|---|---|---|---|---|---|---|
| | | drawing | strength | Modulus | at break | at break |
| | Blend | ratio | GPa | GPa | J/g | % |
| Compar- | PE only | 117.3 | 1.92 | 120.4 | 18.8 | 1.70 |
| ative | | | | | | |
| tape A | | | | | | |
| Tape 1 | Blend 1 | 100.1 | 1.72 | 109.6 | 17.2 | 1.65 |
| Tape 2 | Blend 2 | 92.8 | 1.20 | 97.7 | 10.4 | 1.40 |
| Tape 3-A | Blend 3 | 106.1 | 1.32 | 100.8 | 10.6 | 1.35 |
| Tape 3-B | Blend 3 | 120.3 | 1.35 | 111.0 | 10.3 | 1.30 |
| Tape 3-C | Blend 4 | 90.1 | 1.42 | 90.2 | 13.7 | 1.60 |

The adhesive properties of the tapes were tested as follows:

Terminal ends of tapes were pressed together in line at an overlap of 5 mm in a Fontijne SRB 150 press between paper and felt sheets at 120° C. and 25 ton for 5 sec.

The adhesion force is the maximum force that the material can support without fracture and was determined with a tensile tester at a speed of 50 mm/min. The specific force was calculated as the adhesion force divided by the width of the tape. The results are given in the next table.

| | | adhesion force F | tape width w | F/w |
|---|---|---|---|---|
| | Blend | N | mm | kN/m |
| Comparative tape A | PE only | 92 | 7.63 | 12.0 |
| Tape 1 | Blend 1 | 122 | 8.10 | 15.0 |
| Tape 2 | Blend 2 | 180 | 8.23 | 21.9 |
| Tape 3-A | Blend 3 | 144 | 9.00 | 15.9 |
| Tape 3-B | Blend 3 | 132 | 9.00 | 14.6 |
| Tape 3-C | Blend 4 | 177 | 8.74 | 20.2 |

In all cases the adhesion force of the tapes prepared from the blends is higher that that of the tape not containing the thermoplastic elastomer, indicating the effect of the presence of thermoplastic elastomer.

### Example 2

### Disentangled Ultra-High Molecular Weight Polyethylene with a Styrene-Butadiene-Styrene Block Copolymer

A polymer blend was obtained as follows: Into a 300 1 beakerglass containing 100 ml solvent, 2.70 g SBS (Styroflex 2G66 (BASF)) was added while continuously stirring. After dissolution, 50 g of disentangled PE (University of Loughborough) was added together with the stepwise addition of 200 ml toluene and mixed thoroughly. The mixture was put in a vacuum oven at 40° C. for approx. 12 h. The mixture was stirred 3-4 times. The resulting material was a free-flowing powder. Manufacturing and composition details are presented in the following table.

| | | | | wt % SBS |
|---|---|---|---|---|
| | | polyethylene | SBS | (on total of PE and |
| | Solvent | (gram) | (gram) | SBS) |
| Blend 4 | Toluene | 50 | 2.70 | 5.1 |

A tape was prepared from the blend as follows:

A mold with a cavity of 620*30 mm was filled with 25 g polymer powder and compressed at 120° C. at 140 bar for 7 min to form a sheet.

The sheet was preheated at 118° C. for 1 min, and rolled 3 times with a Collin Calander (diameter rolls: 250 mm, inlet speed 0.5 m/min, 125°) at a slit distance of 0.3 mm, 0.2mm and 0.15 mm respectively. The tape was immediately stretched on a roll at a slit distance of 0.15 mm (speed 2.5 m/min). The tape was stretched in two steps on a 50 cm long oil heated hotplate at 136° C. The tape made contact with the hotplate after 20 cm from the entrance of the hotplate. The properties of the tape, and those of a tape of the same polymer not containing the thermoplastic elastomer, are given in the next table.

| | | | Tensile | | Energy | Elongation |
|---|---|---|---|---|---|---|
| | | drawing | strength | Modulus | at break | at break |
| | Blend | ratio | GPa | GPa | J/g | % |
| Compar- | PE only | 166 | 3.09 | 131.6 | 48.9 | 2.80 |
| ative | | | | | | |
| tape B | | | | | | |
| Tape 4 | Blend 4 | 175 | 2.60 | 111.1 | 43.3 | 2.85 |

The adhesive properties of the tapes were tested as follows:

Terminal ends of tapes were pressed together in line at an overlap of 5 mm in a Fontijne SRB 150 press between paper and felt sheets at 20 s at 135° C. at 25 ton. The temperature was measured with a Fluke 5411 thermometer with thermocouple (type K).

The adhesion force is the maximum force that the material can support without fracture and was determined with a tensile tester at a speed of 50 mm/min. The specific force was calculated as the adhesion force divided by the width of the tape. The results are given in the next table.

| | | F | w | F/w |
|---|---|---|---|---|
| Sample name | Blend | N | mm | kN/m |
| Comparative tape B | PE only | Pressed tape fall apart | | |
| Tape 4 | Blend 4 | 6 | 7.75 | 0.8 |

It appears that for the distentangled PE used in this example the use of a blend with a thermoplastic elastomer makes it possible adhere tapes to each other. Without the thermoplastic elastomer this is not possible.

1. A process for manufacturing a polyolefin powder comprising a thermoplastic elastomer, which process comprises
combining a polyolefin powder or a monomeric source therefor with a thermoplastic elastomer, the thermoplastic elastomer being in the form of a solution or dispersion in a solvent,
wherein where a monomeric source of a polyolefin is used, contacting the monomeric source of a polyolefin with a catalyst under polymerization conditions to form a polyolefin, and
removing the solvent to form a powder and wherein the polyolefin and the thermoplastic elastomer are not the same polymer.

2. A process for manufacturing a polyolefin film comprising a thermoplastic elastomer, which process comprises
subjecting a polyolefin powder containing a thermoplastic elastomer to a compacting step and a stretching step under such conditions that at no point during the processing of the polymer is a temperature thereof raised to a value above a melting point of the polyolefin.

3. A process for manufacturing polyolefin fibers comprising a thermoplastic elastomer, which process comprises
subjecting a polyolefin film comprising a thermoplastic elastomer to a mechanical division process.

4. A process according to claim 1, wherein the polyolefin powder is nascent polyolefin powder.

5. A process according to claim 1, wherein the polyolefin comprises polyethylene with a molecular weight of at least 100,000.

6. A particulate polyolefin composition which has a particle size distribution such that at least 80 vol. % of the particles has a diameter in the range of 1-3000 microns, and which comprises a nascent polyolefin and 0.1-30 wt. % of a thermoplastic elastomer, calculated on the total of polyolefin and thermoplastic elastomer.

7. A polyolefin film obtainable from the particulate polyolefin composition of claim 6 which comprises polyolefin and a thermoplastic elastomer, wherein the thermoplastic elastomer is present within the polyolefin film.

8. A polyolefin fiber obtainable from the particulate polyolefin composition of claim 6 which comprises polyolefin and a thermoplastic elastomer, wherein the thermoplastic elastomer is present within the polyolefin fiber.

9. Ballistic-resistant molded article comprising a compressed stack of sheets, each sheet comprising reinforcing elongate bodies, the direction of the elongate bodies within the compressed stack being not unidirectional, wherein the elongate bodies are
polyolefin films in accordance with claim 7,
polyolefin fibers that comprise polyolefin and a thermoplastic elastomer, wherein the thermoplastic elastomer is present within the polyolefin fibers,
polyolefin films manufactured via a process comprising subjecting a polyolefin powder containing a thermoplastic elastomer to a compacting step and a stretching step under such conditions that at no point during the processing of the polymer is a temperature thereof raised to a value above a melting point of the polyolefin,
polyolefin fibers manufactured via a process that comprises subjecting a polyolefin film comprising a thermoplastic elastomer to a mechanical division process,
or combinations thereof.

10. (canceled)

11. A process according to claim 2, wherein the polyolefin powder is nascent polyolefin powder.

12. A process according to claim 3, wherein the polyolefin powder is nascent polyolefin powder.

13. A process according to claim 2, wherein the polyolefin comprises polyethylene with a molecular weight of at least 100,000 gram/mole.

14. A process according to claim 3, wherein the polyolefin comprises polyethylene with a molecular weight of at least 100,000 gram/mole.

15. A process according to claim 1, wherein the polyolefin comprises polyethylene with a molecular weight of at least 300,000 gram/mole.

16. A process according to claim 2, wherein the polyolefin comprises polyethylene with a molecular weight of at least 300,000 gram/mole.

17. A process according to claim 3, wherein the polyolefin comprises polyethylene with a molecular weight of at least 300,000 gram/mole.

18. A process according to claim 1, wherein the polyolefin comprises polyethylene with a molecular weight of at least 500,000 gram/mole.

19. A process according to claim 2, wherein the polyolefin comprises polyethylene with a molecular weight of at least 500,000 gram/mole.

20. A process according to claim 3, wherein the polyolefin comprises polyethylene with a molecular weight of at least 500,000 gram/mole.
